(19) United States
(12) Patent Application Publication
(10) Pub. No.: US 2008/0292832 A1
(43) Pub. Date: Nov. 27, 2008

(54) Structural component in the form of a heat shield

(75) Inventors: Beate Zika-Beyerlein, Nurnberg (DE); Peter Scholzel, Happurg (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: ElringKlinger AG, Dettingen/Erms (DE)

(21) Appl. No.: 12/153,065

(22) Filed: May 13, 2008

(30) Foreign Application Priority Data
May 25, 2007 (DE) 10 2007 024 553.1

(51) Int. Cl. B32B 7/04; B32B 3/30; B32B 3/10

(52) U.S. Cl. 428/91; 428/133

(57) ABSTRACT

The invention relates to a structural component in the form of a heat shield, consisting of at least two interconnected structural layers, of which one structural layer (10) has a first type of depressions (14), which is oriented in the direction of the other structural layer, and of which the other structural layer has a second type of depressions (16), which is oriented in the direction of the first structural layer (10), and which is provided at least partially with a perforation or forms the perforation itself. In that the two structural layers are located on top of one another such that the second type of depressions (16) fits at least partially between the first type of depressions (14) and in that the respective structural layer on its side facing away from the depressions (14, 16) has surface regions (30) with a closed surface, a structural component is formed which requires less installation space and still has good noise-insulating and heat-insulating properties.

The invention relates to a structural component in the form of a heat shield, consisting of at least two interconnected structural layers, of which one structural layer has a first type of depressions, which is oriented in the direction of the other structural layer, and of which the other structural layer has a second type of depressions, which is oriented in the direction of the first structural layer, and which is provided at least partially with a perforation or forms the perforation itself.

Structural components made as heat shields are known in various embodiments and are widely used in particular in automotive engineering. As a heat shield these structural components are designed to keep the heat released via radiation and/or convection from exhaust-carrying parts of internal combustion engines, turbochargers, and especially catalytic converters, away from adjacent components or body parts. Since the pertinent parts to be shielded are not only heat sources, but also noise sources, in addition to heat insulation, favorable acoustic shielding behavior is also extremely important.

DE-A-40 35 177 discloses a heat shield for shielding of exhaust-carrying parts on a motor vehicle, which has a reflector sheet which forms the front of the shield. In the reflector sheet there are several openings arranged in a grid, behind each opening there being a noise-absorbing chamber on the rear of the shield. The chambers themselves are formed by depressions of the chamber sheet metal which is attached to the reflector sheet metal. The indicated chambers are used in the known solution for sound absorption and they increase heat insulation. To enable recycling, all parts of the heat shield are preferably produced from a uniform material. The reflector sheet metal is furthermore securely joined to the so-called chamber sheet metal by way of a plurality of welds.

DE-A-199 25 492 discloses a thermal shielding sheet with two macrostructured, shaped sheet metal parts as individual structural layers. The two macrostructured, shaped sheet metal parts are interconnected via weld spots and via folds in the edge regions. The individual directions in which the macrostructured, shaped sheet metal parts run deviate from one another such that the depressions which form the macrostructure have different distances or widths to one another. In one especially preferred embodiment of the known solution, it is provided that between the macrostructured, shaped sheet metal parts there is another layer consisting of several aluminum foils in order in this way to improve the heat shielding function. In order to prevent heat from accumulating between the first and second macrostructured, shaped sheet metal parts, it is furthermore provided that passages in the manner of a perforation be formed in the surface regions of the first shaped sheet metal part, which regions run flat and to the outside on the side facing away from the heat and noise source.

EP-A-0 806 555 discloses a heat shield, especially for shielding of exhaust-carrying parts in motor vehicles, with at least one metallic insulating layer located between two cover layers, at least one insulating layer being formed by a sheet metal part which has been structured by means of a plurality of piercings, or a foil, and the burr of the piercings being slotted, jagged, or tongue-shaped. These burr parts in the known solution merely cause spot thermal contacts to adjacent layers or to the cover layers which preferably consist likewise of metal. If the burrs are advantageously bent to the outside, they cause spot doubling of the material thickness of the sheet metal part or the foil.

DE-C-197 23 943 likewise discloses a heat shield with an insulating layer located in the middle between two sheet metal cover layers in the form of a jagged sheet with openings in the manner of a perforation in both directions, that is, oriented toward the respective cover layer. In a continuation of the above described solution, some of the jagged burrs which are formed by the perforation are used to join the two sheet metal cover layers to one another, conversely the other burr parts or jagged parts extend with a distance provided between the two cover layers toward the latter without engaging them. In this way, within a shielding part smaller regions form with the indicated jagged connection and larger shielding regions form without this engagement.

DE-U-203 193 910 discloses a generic, acoustically active heat shield consisting of at least two metal foils, preferably of aluminum, which each have a plurality of nap-like embossed points, at least one of the metal foils being perforated. The perforated metal foil has a plurality of holes with an average hole diameter in the range from 0.05 to 0.9 mm, the holes being arranged in a density of at least 15 holes per cm² in the metal foil, and the perforated metal foil on one side, preferably over the entire surface, being provided with an adhesive layer which can be thermally activated above 120° C. and which has a corresponding perforation. In the known structural component solution, the nap-like embossed points of the two structural layers in the form of metal foils abut one another, and viewed in cross section the respective metal foil forms a corrugated shape, the individual corrugations passing into one another in direct succession.

With respect to this prior art, the object of the invention is to devise a structural component which requires less installation space and in a simple construction enables economical production, is reliable in use, and in addition to good heat-insulating action also enables very effective noise insulation.

According to the invention this object is achieved by a structural component which has the features of claim 1 in its entirety.

The structural component according to the invention in the form of a heat shield according to the characterizing part of claim 1 is characterized in that the two structural layers are located on top of one another such that the second type of depressions fits at least partially between the first type of depressions and that the respective structural layer on its side facing away from the depressions has surface regions with a closed surface.

One structural layer with the first type of depressions in this case is located on the side facing away from the noise source and/or heat source. The otherwise closed surface which preferably forms a flat surface region with a first type of depressions can then be structured, depending on the respective application, such that both the penetration depth and also the shape of the respective depression as well as the distance between the individual adjacent depressions can be made variable. As a result of the structuring obtained in this way, the sound waves delivered by the individual insulating layers of the structural part which is made as a sandwich on the inside of the first structural layer are not reflected in the same direction, as they strike there, but are reflected refracted and therefore diffusely. This means on the one hand that the respective sound wave being reflected takes a longer route through the absorber which has been formed in this way, and thus more energy can be removed from it, and on the other hand that in the region of the original source of the sound too few overlaps can occur and therefore summation of the emitted and reflected acoustic waves cannot take place.

As a result of the alternating engagement with the spaces formed by the respective type of depressions of the first and second structural layer, the structural component solution according to the invention in terms of its installation height can be designed to be uniform and therefore space-saving, the contributing factor also being that for the effectiveness of shielding no additional components are necessary, such as intermediate foils between the structural layers. Since the use of additional adhesive sites or other connecting sites such as welds for joining the structural layers to one another can be dispensed with, the structural component according to the invention can be produced not only extremely economically, but is also reliable in use for high temperature applications; that is, in temperature ranges in which adhesive sites can detach or weld spots can fail by “oxidizing”.

The surface regions of the respective structural layer which run essentially closed to the outside and which are interrupted only by the depressions and/or by the respective perforation, on the whole lead to a buckling-resistant overall structure, however, the structural layers can be easily adapted on site to the circumstances by corresponding deformation as a result of the continuous surface regions which are kept relatively flexible; this is done by the structural component being matched to the respective heat and noise source by bending of the outside contour, for example, formed by the exhaust manifold of an exhaust-carrying part, the outside contour of a catalytic converter means, etc.

In one preferred embodiment of the structural component according to the invention, it is provided that the first and the second type of depressions are arranged in uniformly distributed groups on the respectively assigned structural layers and that the respective groups to one another and also the depressions of one group among one another have essentially the same distance to one another. It is especially preferably provided that one group of four depressions of the first or second type accommodates a single depression of the second or first type respectively between themselves. The uniform spacing of the groups among one another, with inclusion of the fact that in a top view parts of the depressions of the first and second type overlap in corner regions with a preferably rectangular, in particular square area, in terms of vibration behavior yielded especially good absorption behavior.

It is furthermore preferably provided that as the insulating layer between the individual structural layers, preferably formed from a sheet metal material, there is an acoustically, highly effective, high temperature-resistant insulating layer. The combination of structural layers in a sandwich structure is preferably produced by means of flanging of the unperforated first structural layer as the outside layer.

As a result of the special structuring in which sound admission via the second type of depressions of the second structural layer into the interior of the sandwich structure is ensured, especially in conjunction with acoustically highly effective insulation, a distinctly improved acoustic shielding action over a wide excitation region is effected, the second type of depressions with its free opening entry facing the respective noise source and/or heat source. In spite of the distinctly improved acoustic shielding action, the structural component according to the invention can be used for applications exposed to high thermal loads, for example within motor vehicles.

In one especially preferred embodiment of the structural component according to the invention, the respective first and second type of depressions are made funnel-shaped. The respective bottom of the first type of depressions here is preferably napped, at least for some of the bottoms of the second type of depressions as the perforation, there being one passage at a time which can also be bordered by the funnel-shaped depression itself. As a result of the use of structural funnels, on the one hand the noise which is incident on the structural component can be easily integrated within the sandwich structure and scattered diffusely with the correspondingly long transit times; this leads to very good acoustic insulating values for the structural component. In this connection it has also proven advantageous to choose the penetration depth of the depressions of the first and second type to be essentially identical and the number of depressions of the first type to be larger than the number of depressions of the second type relative to the surface section of the overall structural layers under consideration.

Other advantageous embodiments of the structural component according to the invention are the subject matter of the other dependent claims.

The invention will be detailed below using the drawings.

FIG. 1 shows a detached, partial top view of the first structural layer of the structural component according to the invention in a corresponding enlargement;

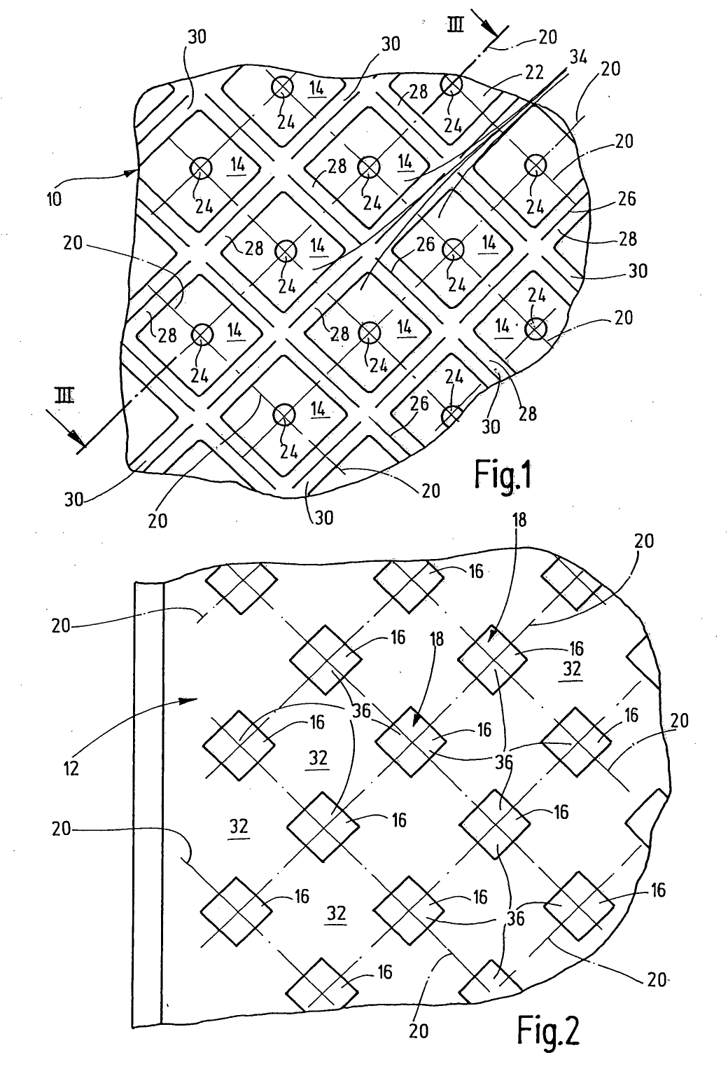

FIG. 2 shows a detached, partial top view of the bottom of the second structural layer of the structural component;

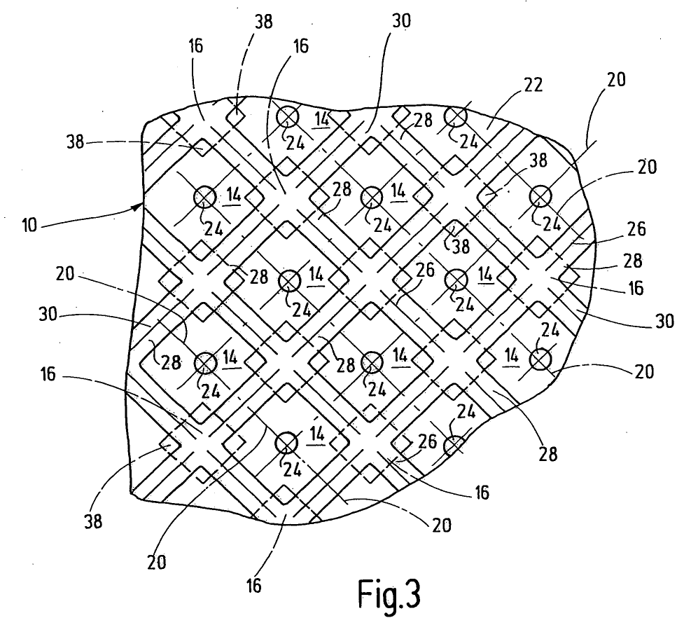

FIG. 3 shows a partial top view of the first structural layer as shown in FIG. 1 with a second structural layer as shown in FIG. 2 located congruently underneath;

FIG. 4 shows a partial section along line III-III in FIG. 1;

FIG. 5 shows a side view of an insulating layer as is inserted between the individual structural layers of the structural component, as was, however, omitted in FIG. 3 for clarity,

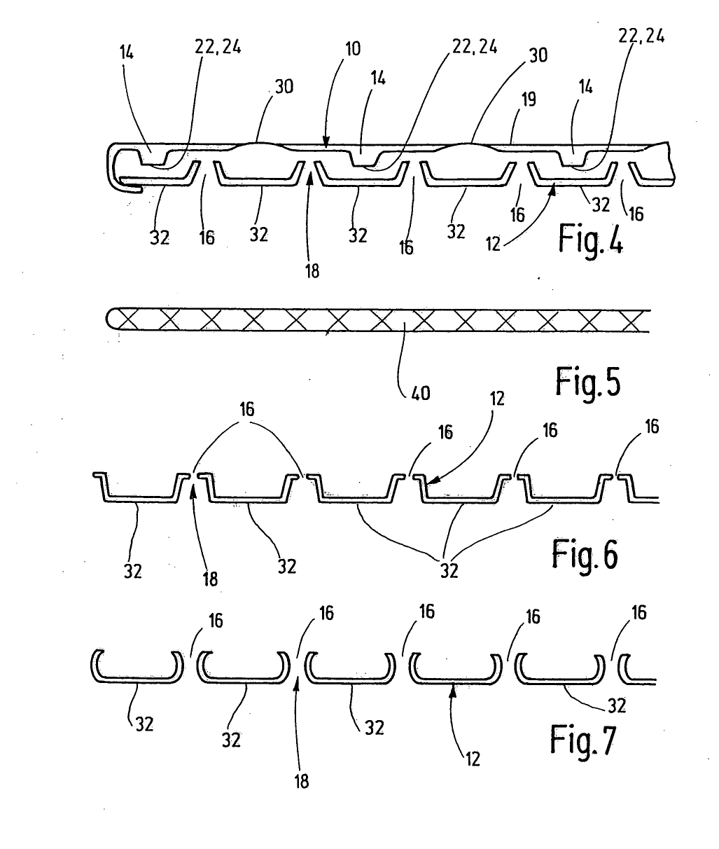

FIGS. 6 and 7 show in a side view two different embodiments of structural layers as can be used in the solution as shown in FIGS. 1 to 3.

The structural component according to the invention, in particular made in the manner of a noise-insulating heat shield, consists essentially of two structural layers 10, 12 which can be joined to one another, FIG. 1 showing the upper structural layer 10, FIG. 2 the lower structural layer 12, FIG. 3 showing the arrangement of the first and second structural layer 10, 12 on top of one another, and FIG. 4 showing in a side view the combination of the first structural layer 10 and second structural layer 12 near the edge. In practical applications one upper structural layer 10 is located stationary facing away from the respective noise and heat source and the other, second structural layer 12 is fixed facing this source. The first structural layer 10 has a first type of depressions 14, which, as shown in particular by FIG. 3, is oriented in the direction of the other structural layer 12, the other structural layer 12 having a second type of depressions 16, which is oriented in the direction of the first structural layer 10 and which is provided at least partially with a perforation (designated as a whole as 18). Both type of depressions 14, 16 extend along imaginary connecting lines 20 which are more or less perpendicular to one another and which maintain the same distances to one another. In this way a type of grid distribution size arises which can be freely selected depending on the respective application for the structural component.

As is shown in particular by FIG. 4, the respective first and second types of depressions 14, 16 are made funnel-shaped, the respective bottom 22 of the first type of depressions 14 being made napped, and the individual bottom naps 24, as shown in particular in FIG. 1, having a circularly cylindrical shape. The funnel shape for this first type of depressions 14 is embossed in the shape of a nap, this nap shape being very easily obtained by means of a conventional forming process which is applicable in particular when the respective structural layer 10, 12 consists of a sheet metal material which can be shaped, even in a high-grade steel version. As furthermore follows from FIG. 1, the depressions 14 of the first type are bordered by projecting wall sections which extend along boundary lines 26 which extend in a comparable grid size like the imaginary connecting lines 20 parallel to them along the structural layer 10. The indicated wall sections form surface sections 28 which are made in the manner of ribs and which accordingly stiffen the upper structural layer 10 and in this respect can counteract vibrations in use of the structural component.

For good damping action it has proven effective to make the penetration depth of the depressions of the first and second type 14, 16 more or less identical (cf. FIG. 4), the number of depressions of the first type 14 being chosen to be greater than or equal to the number of depressions of the second type 16. This benefits the diffusor properties of the structural component. As FIG. 2 shows in particular, the depressions of the second type 16 viewed in cross section are made rectangular, in particular square, and are punched by means of a piercing tool on the bottom (skewering) such that the perforation 18, consisting of square individual passages or openings, is formed directly by the boundary wall of the funnel. But in contrast, for an altered embodiment of the structural layer 12 as shown in FIG. 6, it is also possible to leave parts of the bottom as is and preferably make the perforation 18 in the middle in the bottom.

In another embodiment as shown in FIG. 7 for the structural layer 12, it is also possible to provide the added funnel with its boundary wall sections widening to the inside so that viewed in cross section a type of hyperboloid of rotation, formed by the wall sections of the funnel, is formed. This hyperboloid shape has also proven effective for sound insulation. The respective depression, however, can also form a rhombic, truncated pyramidal cutout. The respective cutout can form the perforation 18 for the second structural layer 12; but it is also possible to produce this depression 16 and then add the perforation (not shown) to the free face side.

Between the depressions 14 and 16 the two structural layers 10, 12 have surface regions 30, 32 with an essentially closed surface. According to the embodiment as shown in FIGS. 1 to 4, the structural component is made as a plate which runs flat, so that the surface regions 30, 32 are arranged running parallel to one another and assume a uniform installation distance to one another. The respective arrangement shown, however, can also be shaped into almost any three-dimensional structures (not shown) as an overall structural component in order in this way to be matched to heat-generating and/or noise-generating means in order, for example, to follow the outside contour of an exhaust manifold, a catalytic converter or the like.

As FIG. 1 shows, the first type of depressions 14 is distributed uniformly over the first structural layer 10 and in the manner of cutouts forms first groups 34 with four depressions 14 each. Likewise, as shown in FIG. 2, the depressions 16 of the second type can be viewed in second groups 36 with four group members each arranged adjacent to one another in the form of depressions 16 of the second type. As follows furthermore from FIGS. 1 and 2, the respective group members in the form of individual depressions assume the same distance from one another within each group 34, 36. The indicated identical spacing between the same group members and group members of a different type is apparent from the top view shown in FIG. 3, in which the two structural layers 10, 12 are shown on top of one another. For vibration absorption behavior it has proven especially favorable if, as shown in FIG. 3, some of the depressions of the first and second type 14, 16 overlap one another in corner regions 38 with a preferably rectangular, in particular square surface.

Preferably it is furthermore provided that at least one insulating layer 40 be placed between the two structural layers 10, 12, as is shown by way of example in FIG. 5. The insulating layer 40 which preferably consists of a fiber material or nonwoven material can be, arranged as a layer like a sandwich between the two structural layers 10, 12, but it is also possible to provide the entire cavity between the two structural layers 10, 12 with an insulating layer 40, for example, by means of an injection process. These insulating layers 40 are easily available commercially in a host of embodiments so that they will not be detailed here. Since the other, second structural layer 12 likewise consists of a sheet metal part, for example, in the form of a stamping, the entire structure, that is, the structural component, can also bend along definable contours, for example, can be shaped as a half shell and the like.

With the structural component according to the invention, a highly effective noise-insulating damping means is available to the engineer and moreover satisfies without difficulty thermal demands with respect to long-term resistance.

1. A structural component in the form of a heat shield, consisting of at least two interconnected structural layers (10, 12), of which one structural layer (10) has a first type of depressions (14), which is oriented in the direction of the other structural layer (12), and of which the other structural layer (12) has a second type of depressions (16), which is oriented in the direction of the first structural layer (10), and which is provided at least partially with a perforation (18) or forms the perforation itself, characterized in that the two structural layers (10, 12) are located on top of one another such that the second type of depressions (16) fits at least partially between the first type of depressions (14) and that the respective structural layer (10, 12) on its side facing away from the depressions (14, 16) has surface regions (30, 32) with a closed surface.

2. The structural component according to claim 1, wherein the first and the second type of depressions (14, 16) are arranged in uniformly distributed groups (34, 36) on the respectively assigned structural layer (10, 12) and wherein the respective groups (34, 36) to one another and also the depressions (14, 16) of one group (34, 36) among one another have essentially the same distance to one another.

3. The structural component according to claim 2, wherein one group (34, 36) of four depressions of the first or second type (14, 16) accommodates a single depression of the second or first type (16, 14) respectively between themselves.

4. The structural component according to claim 3, wherein in its top view some of the depressions of the first and second type (14, 16) overlap in corner regions (38) with a preferably rectangular, in particular square, area.

5. The structural component according to claim 1, wherein the respective first and second type of depressions (14, 16) are made funnel-shaped.

6. The structural component according to claim 5, wherein the respective bottom (22) of the first type of depressions (14) is made napped, in particular has a circularly cylindrical shape.

7. The structural component according to claim 5, wherein at least for a part of the bottoms of the second type of depressions (16) as a perforation (18) they have one passage at a time which can also be bordered by the funnel-shaped depression itself.

8. The structural component according to claim 1, wherein the penetration depth of the depressions of the first and second type (14, 16) is essentially the same and wherein the number of depressions of the first type (14) is larger than the number of depressions (16) of the second type relative to a definable surface cutout.

9. The structural component according to claim 1, wherein the depressions of the second type (16) are made rectangular, in particular square, in cross section.

10. The structural component according to claim 1, wherein the depressions of the first type (14) are bordered by projecting wall sections which extend at least partially along boundary lines (26) which form surface sections (28) which are made in the manner of ribs within one structural layer (10).

11. The structural component according to claim 1, wherein the depressions of the first type (14) fit into the free spaces between the depressions of the second type (16) and the latter in turn into the free spaces of the depressions of the first type (14).

12. The structural component according to claim 1, wherein at least one insulating layer (40) is placed between the two structural layers (10, 12).
